(19) United States
(12) Patent Application Publication
(10) Pub. No.: US 2021/0380460 A1
(43) Pub. Date: Dec. 9, 2021

(54) Method and System for Producing a Glass Container as Well as Said Container

(71) Applicant: Gerresheimer Bünde GmbH, Bunde (DE)

(72) Inventors: Wolfram ACKER, Kiel (DE); Matthias HELLMICH, Bünde (DE); Vladislav LÖPP, Bünde (DE); Rainer VAHLE, Hiddenhausen (DE)

(21) Appl. No.: 17/338,430

(22) Filed: Jun. 3, 2021

(30) Foreign Application Priority Data
Jun. 4, 2020 (DE) 102020114903.4

(51) Int. Cl. C03B 23/08; C03B 23/11; C03B 23/09

(52) U.S. Cl. CPC C03B 23/08; C03B 23/095; C03B 23/112

(57) ABSTRACT

The invention relates to a method for producing a glass container, such as a glass syringe or a glass ampule, having a form-specific dispensing portion and optionally a form-specific counter support, from a glass container blank, wherein the basis weight of the glass container blank is detected indirectly or directly and the overall longitudinal extent of the glass container to be produced is determined on the basis of the detected basis weight.

The invention relates to a method for producing a glass container, such as a glass syringe or a glass ampule. The present invention further provides a glass container, such as a glass syringe or a glass ampule. The present invention also provides a system for producing a glass container, such as a glass syringe or a glass ampule.

Glass containers or glass bodies for glass syringes or glass ampules are subject to very low production tolerances, so that firstly a high product quality can be ensured and secondly the partially standardized interfaces can be observed, for example, in the funnel-shaped end portion. A fundamental influencing factor is the dimension of the wall thickness of the cylindrical glass tube blanks, which are subject to production-related tolerances. A further factor affecting the quality or accuracy of the glass container is provided by the production-specific tolerances when cutting glass container blanks from the glass tube blank, wherein length tolerances arise.

In principle, there is a desire to produce glass containers in predefined, constant overall lengths. This desire is impaired by the aforementioned production tolerances. This is because said tolerances result in different weight masses of the glass container blanks cut from the glass tube blank. Due to the different weight masses of the glass container blanks, the portions for the funnel-shaped end portion or for the radially extending support or flange shoulder that are to be produced by thermoforming cannot be produced consistently or to a predefined length dimension. This leads to increased waste due to losses in quality, in particular in the region of the funnel-shaped end portion or of the support shoulder.

In the prior art, this is achieved by providing excess mass for each glass container which is manifested in excess length. The excess length is produced in particular as a result of the constricting thermoforming in the region of the funnel-shaped end portion and optionally in the region of the radially extending support shoulder giving rise to an excess mass of glass which is compensated for by excess length. Excess lengths extend into the millimeter range. In order to again compensate for the excess length, it is cut off in a downstream process step by means of a mechanical cutting device. However, it was discovered that the cutting step is again subject to production-specific length tolerances on the one hand and on the other hand is associated with frontal surface defects and contamination due to glass particles arising from the cutting process which make further processing, such as sterilization, of the glass syringe body more difficult. Furthermore, the subsequent mechanical cutting causes an offcut which has a negative effect on the costs of the production process.

For example, WO 2005/092805 A1 discloses a glass processing machine with forming tools for thermoforming, for example, a glass tube blank. In WO 2005/092805 A1, as precise an alignment of the position of the forming tools as possible is sought in order to reduce production tolerances, in particular in the constricting deformation region of a nozzle of a glass syringe. This is achieved by measuring the positioning of the glass tube blanks to be formed with respect to the position of the forming tools and comparing setpoint values stored in a control unit in order to achieve higher quality during production. However, WO 2005/092805 A1 does not provide any measure to compensate for, in particular reduce, the production-specific wall thickness dimensional tolerances and length tolerances described above.

An object of the present invention is to provide a method and a system for producing a glass container as well as a glass container, which has a higher quality and/or is subject to lower production tolerances.

The object is achieved by the subject matters of the independent claims.

One aspect of the present invention provides a method for producing a glass container. The glass containers can be, for example, a glass syringe, a glass ampule, a glass carpule or a glass vial. As a rule, the glass containers are rotationally symmetrical. Generic glass containers generally have overall longitudinal extents in the range of from 50 mm to 90 mm and/or in the range of from 6.5 mm to 10.85 mm and/or wall strengths or wall thicknesses in the range of from 0.8 mm to 1.3 mm. The glass containers are produced from a glass container blank which is hollow. The glass container blank can define an axis of rotation with respect to which the glass container blank is formed rotationally symmetrically. In this case, it is also possible to speak of a glass tube blank. The glass container blanks can, for example, be provided continuously, for example from a supply warehouse in which they are stored and which is set up in the immediate vicinity of a glass container production plant. Furthermore, the provision of glass container blanks can be arranged in such a way that they are removed directly from a glass blowing station, in particular in the form of an endless glass container blank. The glass containers to be produced have a form-specific dispensing portion and optionally a form-specific counter support. Form-specific is to be understood in particular to mean that the dispensing portion and optionally the counter support are predetermined in terms of shape and/or geometry, are for example standardized and/or are formed according to defined requirements. The dispensing portion can, for example, be a conical portion. The conical portion may have a frustoconical shape and/or may progressively taper toward a dispensing opening formed at an end face of the glass container or of the dispensing portion. The counter support can be designed as a support or flange shoulder extending radially, that is to say transversely to the direction of longitudinal extent of the glass container, in particular for supporting or placing a finger of an operator. Typically, the counter support is likewise rotationally symmetrical and/or circumferentially surrounds or encloses an in particular cylindrical glass container base body in an annular manner. The dispensing portion and the counter support are typically formed by hot forming. For example, it can be provided that the glass container blank is heated at least in portions up to its transformation temperature and is then formed in a form-defining manner with a forming tool.

According to the method, the basis weight of the glass container blank is detected indirectly or directly and an individual overall longitudinal extent, in particular axial length, of a semi-finished glass container to be formed, in particular thermoformed, to produce the glass container is determined by means of the basis weight detected. The basis weight may also be referred to as cross-section mass and/or can be understood as that mass which the glass container blank has in relation to an infinitesimally small length in the longitudinal direction of the blank. The basis weight thus depends in particular on the density of glass and on the cross-sectional area of the glass container blank, which in turn depends on an external dimensioning, an internal dimensioning and/or a wall thickness of the hollow, in particular cylindrical, tube-like glass container blank. The basis weight can be detected directly or immediately or indirectly or tangentially. For example, the basis weight can be measured. It is also possible for the basis weight via a detection of a variable associated with the basis weight, such as, for example, an internal dimension, in particular an internal diameter, or an external dimension, in particular an external diameter, and/or a wall strength or wall thickness of the glass container blank, and a subsequent assignment of the detected, in particular measured, variable to the basis weight to occur, for example by a calculation or scaling method. For example, the glass container blank is characterized by the raw material which, for example, is prefabricated and/or present in a predetermined blank length.

The semi-finished glass container can be understood to be an intermediate product between the glass container blank present as a raw material and the finished glass container to be produced.

In particular, the semi-finished glass container is characterized in that it no longer has to be cut to length to produce the glass container or is no longer subjected to a cutting process, but rather is produced substantially exclusively by a forming process, in particular a thermoforming process. This means that surface post-processing measures may still be necessary. For example, according to the method it can be provided for an individual overall longitudinal extent of a semi-finished glass container which, in order to produce the glass container, is to be further processed substantially exclusively by forming, in particular by a forming process, such as a thermoforming process, to be determined based on the basis weight detected. The individual overall longitudinal extent of the semi-finished glass container is to be understood as that axial length or overall longitudinal extent of the semi-finished glass container, which the semi-finished glass container must have in order to achieve the desired and/or predetermined glass container length as free of production tolerance as possible and as precisely as possible, wherein above all the glass container blank waste is also reduced, in particular avoided. The excess mass or excess length hitherto provided in the prior art can be dispensed with by individually determining an optimum overall longitudinal extent of the semi-finished glass container. Above all, the downstream cutting process step, which has hitherto been necessary, can thereby be avoided. As a result, distinctly higher-quality glass containers can be produced. Furthermore, the production time is reduced and/or the frequency for the production of glass containers can be increased. For one thing, the inventors of the present invention have found that the glass container blanks can vary in their dimensions and/or their quality, in particular are subject to production tolerances. Furthermore, the inventors of the present invention have found that the variances or production tolerances can be compensated for by determining the individual basis weight of the glass container blanks and by subsequently determining an individual overall longitudinal extent of the glass containers to be further processed to form the glass containers. Furthermore, by means of the method according to the invention, it is possible to produce glass containers of a consistent glass container length, wherein consistent means in particular that the desired and/or predetermined glass container length is produced with very low production tolerances and high production accuracy.

In an exemplary development of the method according to the invention, the semi-finished glass container is cut from the glass container blank according to the determined overall longitudinal extent. In other words, a semi-finished glass container with the individual axial length is separated from the glass container blank, which is then to be formed exclusively in order to create, in particular form, the glass container, in particular it is to be further processed by means of a forming process, such as a thermoforming process, namely wherein one end portion of the semi-finished glass container is to be formed to create the form-specific dispensing portion and optionally an opposing end portion is to be formed to create the form-specific counter support. By creating an individual semi-finished glass container taking into account the basis weight and the associated geometric parameters of the glass container blank, and in particular knowing the form-specific end portions, namely the dispensing portion and optionally the counter support, a glass container with significantly lower production tolerance can be produced.

In a further exemplary embodiment of the present invention, an individual longitudinal extent of an in particular leading end portion, from which the form-specific dispensing portion is to be formed or is formed, is determined on the basis of the detected basis weight of the glass container blank. Optionally, an individual longitudinal extent of an, in particular trailing, second end portion, from which the counter support is to be formed or is formed, can also be determined. The terms trailing and leading can be understood here in relation to a glass blowing forming direction and/or in relation to a processing sequence, wherein, as a rule, the dispensing portion is formed first and then optionally the counter support.

In an exemplary development, the overall longitudinal extent of the semi-finished glass container is determined on the basis of the determined longitudinal extent(s) of the dispensing portion and optionally the counter support. In particular, to produce the glass container from the semi-finished glass container, only the dispensing portion and optionally the counter support are to be created, which is realized by forming, in particular thermoforming. In other words, an idea of the present invention in accordance with the exemplary embodiment is to determine the forming mass of glass, in particular melting mass, required for the forming steps to form the dispensing portion and optionally the counter support, which are predetermined in terms of their size and/or form, in order to avoid waste and to increase product quality. By dint of the individual length of the semi-finished glass container, a glass container of consistent or predetermined length can be produced with a consistent, form-specific dispensing portion and optionally consistent, form-specific counter support, despite the geometric variations and/or production tolerances of the glass container blank.

In a further exemplary embodiment of the method according to the invention, the separated semi-finished glass container is heated at least in portions in order to form the dispensing portion and optionally the counter support. For example, the heating is effected by means of at least one burner. In particular, the semi-finished glass container can be heated in portions in the transformation temperature range. In particular, the semi-finished glass container is heated in the region of the, in particular, leading end portion for the dispensing portion and optionally in the region of the, in particular, trailing end portion for the counter support. In particular, the heat is supplied locally via the determined individual longitudinal extent of the in particular leading end portion for the dispensing portion and optionally of the in particular trailing end portion for the counter support.

According to an exemplary development of the method according to the invention, a deformation behavior, in particular a melting process, of the semi-finished glass container during heating and/or forming of the dispensing portion and optionally of the counter support is anticipated on the basis of a glass-specific material constant. Furthermore, the overall longitudinal extent is determined, in particular calculated, taking into account or on the basis of the anticipated deformation behavior. For example, the individual longitudinal extent of the one end portion for the dispensing portion and optionally of the other portion for the counter support can be determined, in particular calculated, on the basis of the anticipated deformation behavior of the dispensing portion and optionally the counter support, and the overall longitudinal extent of the semi-finished glass container are determined on the basis of the longitudinal extents determined for the dispensing portion and optionally the counter portion.

In another aspect of the present invention, which can be combined with the foregoing aspects and exemplary embodiments, a method for producing a glass container is provided. The glass containers can be, for example, a glass syringe, a glass ampule, a glass carpule or a glass vial. As a rule, the glass containers are rotationally symmetrical. Generic glass containers generally have overall longitudinal extents in the range of from 50 mm to 90 mm and/or in the range of from 6.5 mm to 10.85 mm and/or wall strengths or wall thicknesses in the range of from 0.8 mm to 1.3 mm. The glass containers are produced from a glass container blank which is hollow. The glass container blank can define an axis of rotation with respect to which the glass container blank is formed rotationally symmetrically. In this case, it is also possible to refer to it as a glass tube blank. The glass-container blanks can, for example, be provided continuously, for example from a supply warehouse in which they are stored and which is set up in the immediate vicinity of a glass-container production plant. Furthermore, the provision of glass containers for blanks can be arranged in such a way that they are removed directly from a glass blowing station, in particular in the form of an endless glass container blank. The glass containers to be produced have a form-specific dispensing portion and optionally a form-specific counter support. Form-specific is to be understood in particular to mean that the dispensing portion and optionally the counter support are predetermined in terms of shape and/or geometry, are for example standardized and/or are formed according to defined requirements. The dispensing portion can, for example, be a conical portion. The conical portion may have a frustoconical shape and/or may progressively taper toward a dispensing opening formed at an end face of the glass container or of the dispensing portion. The counter support can be designed as a support or flange shoulder extending radially, that is to say transversely to the direction of longitudinal extent of the glass container, in particular for supporting or placing a finger of an operator. Typically, the counter support is likewise rotationally symmetrical and/or circumferentially surrounds or encloses an in particular cylindrical glass container base body in an annular manner. The dispensing portion and the counter support are typically formed by thermoforming. For example, it can be provided that the glass container blank is heated at least in portions up to its transformation temperature and is then in a formed in a form-defining manner with a forming tool.

According to the method, the glass container blank is heated at least in portions in order to form the dispensing portion and optionally the counter support. For example, the heating is effected by means of at least one burner. In particular, the semi-finished glass container can be heated in portions in the transformation temperature range. In particular, the glass container blank is heated in the region of an, in particular, leading end portion for the dispensing portion and optionally in the region of an, in particular, trailing end portion for the counter support.

Furthermore, the basis weight of the glass container blank is detected indirectly or directly before forming the dispensing portion and optionally the counter support. The basis weight can be understood to be that measure which the glass container blank has in relation to an infinitesimally small length in the longitudinal direction of the blank. In other words, the basis weight can be understood as the mass of a cross-sectional area of the glass container blank. The basis weight thus depends in particular on the density of glass and on the cross-sectional area of the glass container blank, which in turn depends on an external dimensioning, an internal dimensioning and/or a wall thickness of the hollow, in particular cylindrical, tube-like glass container blank. The basis weight can be detected directly or immediately or indirectly or tangentially. For example, the basis weight can be measured. It is also possible for the basis weight via a detection of a variable associated with the basis weight, such as, for example, an internal dimension, in particular an internal diameter, or an external dimension, in particular an external diameter, and/or a wall strength or wall thickness of the glass container blank, and a subsequent assignment of the detected, in particular measured, variable to the basis weight to occur, for example by a calculation or scaling method. For example, the glass container blank characterizes the raw material, which is prefabricated for example and/or is present in a predetermined blank length.

In the method, an individual longitudinal extent of an in particular leading end portion, from which the form-specific dispensing portion is to be formed or is formed, is determined on the basis of the detected basis weight of the glass container blank. Optionally, an individual longitudinal extent of an, in particular trailing, second end portion, from which the counter support is to be formed or is formed, can also be determined. The terms trailing and leading can be understood here in relation to a glass blowing forming direction and/or in relation to a processing sequence, wherein, as a rule, the dispensing portion is formed first and then optionally the counter support.

According to the second aspect of the invention, an axial deformation point on the glass container blank is determined on the basis of the determined longitudinal extent(s), namely of the individual longitudinal extent for the dispensing portion and optionally for the counter support, in order to create the dispensing portion and optionally the counter support. Axial here is to be understood in relation to a longitudinal direction of a glass container blank. Knowing the individual longitudinal extent of the dispensing portion and optionally the counter support, the axial deformation point on the glass container blank can be determined as a function of the individual glass container blank, in particular its geometry, size and/or production tolerances, at which a deformation of the glass container blank for creating, in particular forming, the dispensing portion and optionally the counter support is to take place, without it being necessary to provide excess mass and/or length in order to compensate for any production tolerances which may be present. By individually determining the deformation point as a function of the geometric conditions on the individual glass container blank, the optimum axial deformation point can be determined and adopted or applied as far as possible.

As a rule, the forming, in particular thermoforming, of the dispensing portion and the counter support is effected by at least one forming roller, in particular by a pair of mutually associated and opposing forming rollers which can be brought into form rolling contact with the glass container blank or the semi-finished glass container for forming. The forming rollers typically have a substantially cylindrical structure or are conical in shape. In an exemplary development, the axial deformation point on the glass container blank for the dispensing portion and optionally the counter support is determined on the basis of the determined longitudinal extent(s) of the end portion for the dispensing portion and optionally of the end portion for the counter support and on the basis of a predefined or predetermined axial length of the glass container. Knowing the basis weight of the individual glass container blank and the individual longitudinal extent of the end portions for the dispensing portion and optionally the counter support derived therefrom, it can reliably be ensured that the forming and melting mass of glass can be kept constant for the dispensing portion and optionally the counter support and/or that the dispensing portion and optionally the counter support can be produced according to a form specification stipulated, for example, under a standardization in which both the glass mass for the dispensing portion and the counter support and also their dimensions, in particular external diameter, internal diameter and/or wall thickness, can be indicated.

In an exemplary embodiment of the present invention, the axial deformation point is defined such that an axial end portion of the glass container blank delimited by an axial deformation point has a predetermined mass for shaping the dispensing portion and optionally the counter support, in particular a predetermined forming and/or melting mass. It can thereby be ensured that the dispensing portions predetermined in terms of their shape and/or size and, optionally, the counter support predetermined in terms of its shape and/or size reliably have the predetermined mass of glass. This significantly increases the product quality. Furthermore, waste can be avoided. Unnecessary excess mass or length can be prevented, as a result of which, in particular, the separating step then necessary to compensate the excess mass or length, which on the one hand means an additional process step and thus costs, and on the other hand is again subject to production tolerances and generates waste, is also dispensed with.

In a further exemplary embodiment of the method according to the invention, according to an overall longitudinal extent which is predefined or predetermined, in particular determined according to the first aspect of the method according to the invention, a semi-finished glass container, which is to be formed, in particular to be formed exclusively and/or exclusively by a forming process, such as a thermoforming process, and which is to be further processed to produce the glass container, is cut off from the glass container blank. The material difference between the glass container blank and the semi-finished glass container consists in the fact that substantially exclusively the semi-finished glass container is still to be further processed by forming, in particular thermoforming, in order to produce the glass container. However, surface treatment measures may of course also be necessary. It is no longer necessary, however, to cut off the semi-finished glass container and/or to make portions thereof in order to compensate for excess mass or length. The semi-finished glass container is produced according to a corresponding axial length that is selected, in particular optimized, in such a way that the glass container is finished when the dispensing portion and optionally the counter support are subsequently created, wherein a high production accuracy is achieved.

In a further exemplary embodiment of the method according to the invention, a flatness, also referred to as planarity, which may be a measure of a surface quality, of an axial end face of the glass container blank or of the cut semi-finished glass container is determined, in particular measured. A flatness sensor can be used in this respect. For example, the flatness sensor may have a measuring range of 6.4 mm, a resolution of 2 μm, a repeatability of ±0.2 μm and/or a sampling rate of 0.65 kHz in order to achieve reliable and reproducible results. The inventors of the present invention have found that the flatness of the end face of the glass container blanks or semi-finished glass containers to be processed, in particular by forming, such as thermoforming, in particular in a forming tool, has an effect on the production precision in that the flatness of the end face affects the positioning in particular with respect to the axial direction during a subsequent forming step of the creation of the dispensing portion and optionally of the counter support. By measuring the flatness of the end face, positioning tolerances or insertion tolerances in a forming tool can be reduced, in particular avoided.

In a further exemplary embodiment of the method according to the invention, the glass container blank or the cut semi-finished glass container is positioned on the basis of the axial deformation point and optionally of the flatness of the axial end face with respect to a forming tool, such as at least one forming roller, in particular a forming roller pair, for creating the dispensing portion and optionally the counter support. The dispensing portion and the counter support are typically created by forming, in particular thermoforming. Due to the additional information with respect to the axial deformation point and the flatness, if applicable, the glass container blank to be formed or the semi-finished glass container to be formed can be inserted into the forming tool as optimally as possible, so that the form-specific regions for the dispensing portion and optionally the counter support can be produced as exactly as possible in order to achieve as low production tolerances as possible.

According to an exemplary development of the method according to the invention, a deformation behavior, in particular a melting process, of the semi-finished glass container or the glass container blank during heating and/or during forming of the dispensing portion and optionally of the counter support is anticipated on the basis of a glass-specific material constant. Furthermore, the longitudinal extent of the dispensing portion to be formed and optionally of the counter support to be formed is/are determined, in particular calculated, taking into account or on the basis of the anticipated deformation behavior. For example, the individual longitudinal extent of the one end portion for the dispensing portion and optionally of the other portion for the counter support can be determined, in particular calculated, on the basis of the anticipated deformation behavior of the dispensing portion and optionally the counter support, and the overall longitudinal extent of the semi-finished glass container are determined on the basis of the longitudinal extents determined for the dispensing portion and optionally the counter portion. Knowing the glass-specific material constant for the deformation or melting of glass as well as the predetermined dimensions and/or masses of the finished dispensing portions and optionally the counter support on the finished glass container, the axial length of the respective end portions on the glass container blank or semi-finished glass container, from which the dispensing portion or the counter support are to be produced in each case by means of forming, and associated therewith the axial deformation point, in particular at which the forming tool must engage, can be determined or predicted.

In order to achieve a further exemplary embodiment of the method according to the invention, which may be relevant for all previous aspects and exemplary embodiments, an external diameter, an internal diameter and/or a wall thickness of the glass container blank is detected, in particular measured. For example, the wall thickness sensor may be an optical sensor that can measure the intensity of reflections. Furthermore, the basis weight of the glass container blank can be determined, in particular calculated, on the basis of the measured external diameter, the measured internal diameter and/or the wall thickness. It is clear that the density of glass is known.

According to a further aspect of the present invention, which can be combined with the preceding aspects and exemplary embodiments, a glass container, such as a glass syringe, a glass vial, a glass carpule or a glass ampule, is provided which is or is to be produced in particular from borosilicate glass.

The glass container according to the invention comprises a cylindrical base body, a tapering dispensing portion, in particular a conical portion or frustoconical portion, connecting to the base body, which portion creates or has a front open end of the glass container. Furthermore, the glass container according to the invention comprises a rear end which is in contact with the base body and opposes the dispensing portion and is optionally formed as counter support. For example, the counter support is configured as an annular flange projecting radially outward from the cylindrical base body and encircling the cylindrical base body. For example, the counter support has a flat finger contact surface creating the end face of the glass container, which surface is oriented substantially perpendicular to the axial direction of longitudinal extent of the glass container.

In this aspect of the present invention, the front and rear ends are thermally cut. The thermal cutting can be effected, for example, in accordance with DIN Standard 2310-6 by gas, gas discharge or by beam application. For example, the preferred separation method is based on the fact that very high material stresses, in particular mechanical stresses, are generated locally in the region to be separated, which lead to separation, in particular breaking, rupturing or cracking, of the glass material. For example, a quenching process can be applied in that the material stresses are generated by scribing or without scribing, local heating, and sudden quenching. Optionally, the separation process can be supported by local post-heating. In another exemplary embodiment, a laser process may be employed. The separation process, in particular the scribing, can be prepared by a pulse laser, in particular a highly pulsed laser, in order to locally weaken, in particular perforate, the glass. Alternatively, in a further laser heating step, for example with a CO₂ laser, the weakened point can be heated locally in order to carry out the separation. The laser method is distinguished above all by an increased quality of the parting line.

In the prior art, to date always at least one end has had to be mechanically cut, for example by means of a scribing knife, in order to compensate for the excess mass or length which was configured in order to offset the production tolerances. An advantage of thermal cutting is that complex post-treatment steps of the cut edges or cut surfaces for polishing, smoothing and/or improving surface cracks can be avoided.

In an exemplary embodiment of the glass container according to the invention, the overall longitudinal extent, in particular its axial length, is subject to a tolerance of at least ±0.4 mm, in particular ±0.3 mm, ±0.2 mm or ±0.1 mm. The tolerance is to be understood, for example, with reference to a specification, such as a standardization. Prior art glass containers are subject to significantly greater production inaccuracies or tolerances.

In a further exemplary embodiment of the glass container according to the invention, the glass container is produced in accordance with an aspect or an exemplary embodiment of a method according to the invention.

In another aspect of the present invention, which can be combined with the foregoing aspects and exemplary embodiments, a system for producing a glass container such as a glass syringe or glass ampule, a glass vial, or a glass carpule, is provided. As a rule, the glass containers are rotationally symmetrical. Generic glass containers generally have overall longitudinal extents in the range of from 50 mm to 90 mm and/or external diameters in the range of from 6.5 mm to 10.85 mm and/or wall strengths or wall thicknesses in the range of from 0.8 mm to 1.3 mm. The glass containers are produced from a glass container blank which is hollow. The glass container blank can define an axis of rotation with respect to which the glass container blank is formed rotationally symmetrically. In this case, it is also possible to refer to it as a glass tube blank. The glass-container blanks can, for example, be provided continuously, for example from a supply warehouse in which they are stored and which is set up in the immediate vicinity of a glass-container production plant. Furthermore, the provision of glass containers for blanks can be arranged in such a way that they are removed directly from a glass blowing station, in particular in the form of an endless glass container blank. The glass containers to be produced have a form-specific dispensing portion and optionally a form-specific counter support. Form-specific is to be understood in particular to mean that the dispensing portion and optionally the counter support are predetermined in terms of shape and/or geometry, are for example standardized and/or are formed according to defined requirements. The dispensing portion can, for example, be a conical portion. The conical portion may have a frustoconical shape and/or may progressively taper toward a dispensing opening formed at an end face of the glass container or of the dispensing portion. The counter support can be designed as a support or flange shoulder extending radially, that is to say transversely to the direction of longitudinal extent of the glass container, in particular for supporting or placing a finger of an operator. Typically, the counter support is likewise rotationally symmetrical and/or circumferentially surrounds or encloses in an annular manner an in particular cylindrical, glass container base body. The dispensing portion and the counter support are generally created by thermoforming. For example, it can be provided that the glass container blank is heated at least in portions up to its transformation temperature and is then formed in a form-defining manner with a forming tool. For example, the system can be designed to produce glass containers made of borosilicate glass. The installation can, for example, be designed and configured in such a way that it produces glass containers with a production tolerance of ±0.4 mm, in particular ±0.3 mm, in particular ±0.2 mm or ±0.1 mm.

The system according to the invention comprises a sensor system for indirectly or directly detecting the basis weight of the glass container blank and a processor unit which is designed to determine, on the basis of the detected basis weight, an individual overall longitudinal extent of a semi-finished glass container to be formed for creating the glass container. The semi-finished glass container can be understood, for example, as the intermediate stage between the glass container blank and the finished glass container which is cut from the glass container blank and/or is to be further processed to the glass ratio substantially exclusively by a forming process, in particular thermoforming process, in particular by forming to create the dispensing portion and optionally the counter support.

In an exemplary embodiment of the glass container production system according to the invention, the system further comprises a cutting tool for cutting the semi-finished glass container according to the determined overall longitudinal extent of the glass container blanks. As a result, an individual semi-finished glass container is produced, which compensates for the production inaccuracy and/or tolerances on the glass container blank, so that in the following the glass container is to be generated substantially exclusively by forming without further separation steps being necessary, for example in order to compensate for excess mass or length which was provided in order to offset the inaccuracies present on the glass container blank.

In one exemplary refinement, the sensor system is upstream of the cutting tool. In another exemplary embodiment, the sensor system is associated with or integrated in the cutting device or cutting station, which comprises the cutting tool. The cutting device can furthermore have a chuck for rotating the semi-finished glass container and optionally further bearings, in particular air bearings, for the semi-finished glass container.

In a further aspect of the present invention, which can be combined with the preceding aspects and exemplary embodiments, a system for producing a glass container, such as a glass syringe, a glass ampule, a glass carpule or a glass vial from a glass container blank, is provided.

The system according to the invention comprises a heat source, such as a burner, for heating the glass container blank at least in portions. The heat source can be configured in such a way that it can apply heat substantially exclusively, that is to say to a considerable extent, to a predetermined region, in particular an axial portion of the glass container blank.

Furthermore, the system comprises a forming tool designed to deform the heated glass container blank in order to create the dispensing portion and optionally the counter support. For example, the forming tool has at least one forming roller, in particular a pair of mutually associated and/or opposing forming rollers. The forming roller can be cylindrical or frustoconical, for example. To deform the dispensing portion and optionally the counter support, the forming tool can come into rolling deformation contact with the heated portion of the glass container blank.

Furthermore, the system according to the invention comprises a sensor system for indirectly or directly detecting the basis weight of the glass container blank, wherein the sensor system is upstream of the forming tool. In other words, the basis weight of the glass container blank is detected prior to the deformation for creating the dispensing portion and optionally the counter support.

In addition to the further aspect according to the invention, the system comprises a processor unit designed to determine an individual longitudinal extent of an in particular leading end portion, from which the dispensing portion is to be formed, and optionally of an in particular trailing end portion, from which the counter support is to be formed. Furthermore, the processor unit is designed to determine an axial deformation point on the glass container blank for the forming tool on the basis of the determined longitudinal extent(s) in order to form the dispensing portion and optionally the counter support. Axial here is to be understood in relation to a longitudinal direction of a glass container blank. Knowing the individual longitudinal extent of the dispensing portion and optionally the counter support, the axial deformation point on the glass container blank can be determined as a function of the individual glass container blank, in particular its geometry, size and/or production tolerances, at which a deformation of the glass container blank for creating, in particular forming, the dispensing portion and optionally the counter support is to take place, without it being necessary to provide excess mass and/or length in order to compensate for any production tolerances which may be present. By individually determining the deformation point as a function of the geometric conditions on the individual glass container blank, the optimum axial deformation point can be determined and adopted or applied as far as possible.

In an exemplary embodiment of the system according to the invention, the sensor system for detecting the basis weight comprises an optical sensor device, in particular for measuring an external diameter, an internal diameter and/or a wall thickness of the glass container blank. For example, the wall thickness sensor may be an optical sensor that can measure the intensity of reflections. Furthermore, the basis weight of the glass container blank can be determined, in particular calculated, on the basis of the measured external diameter, the measured internal diameter and/or the wall thickness. It is clear that the density of glass is known. In the alternative or in addition, the optical sensor device can be configured to measure the flatness of an axial end face of the glass container blank or of the cut semi-finished glass container.

In a further exemplary embodiment of the system according to the invention, the system is designed to carry out the production method according to the invention in accordance with one of the aspects or exemplary embodiments described above, in particular in order to produce a glass container in accordance with one of the aspects or exemplary embodiments described above.

In summary, the aspects according to the invention make it possible to produce glass containers with increased quality and with increased production accuracy. The inventors of the present invention have found that the glass container blanks, in particular glass tube blanks, used to produce glass containers, which are designed to be rotationally symmetrical, are subject to manufacturing inaccuracies or tolerances. For one thing, during the cutting of semi-finished glass containers from the glass container blanks, the former then being formed to create the glass containers, length tolerances and flatness tolerances result at the cut surface or cut edge. Furthermore, length tolerances result during forming, which result in particular from the fact that the glass container blanks or semi-finished glass containers used have different wall thicknesses, which manifests in a varying forming or melting mass to be formed, resulting in different lengths for dispensing portion and counter support. The inventors of the present invention have addressed the problem of varying wall thicknesses of the glass container blanks in that they have recognized boundary conditions to be observed for the glass containers to be produced, namely a predetermined or consistent length dimension and consistent or predetermined length dimensions and masses for the dispensing portion and the counter support and also a consistent wall thickness in the region of the counter support and the dispensing portion. Standards exist here, for example, according to which the dispensing portion and optionally the counter support are to be formed. It has surprisingly been found that the existing production tolerances can be counteracted by varying the total mass of the individual glass containers, which results from a variance in the wall thickness in the cylindrical base body portion between the dispensing portion and the opposing end portion of the glass container optionally formed as a counter support, which results in a different individual mass of the cylindrical base body, wherein the framework conditions are met. According to the invention, this is achieved on the one hand by the production of individual semi-finished glass containers which have an individual axial dimension generated on the basis of the respective basis weight of the individual glass container blank. The wall thickness variance flows directly into the basis weight. In a further aspect of the present invention, it has been recognized that, via the individual delivery of the deformation tools for creating the dispensing portion and possibly the counter support and thus via the individual adjustment of the axial deformation point for the dispensing portion and optionally the counter support, the production accuracy can be further increased, namely in particular by the fact that the flatness tolerance, which results when separating the glass container blanks or semi-finished glass containers, can be offset.

Preferred embodiments are included in the dependent claims.

Other properties, features and advantages of the invention become apparent below from the description of preferred embodiments of the invention with reference to the accompanying exemplary drawings, which show:

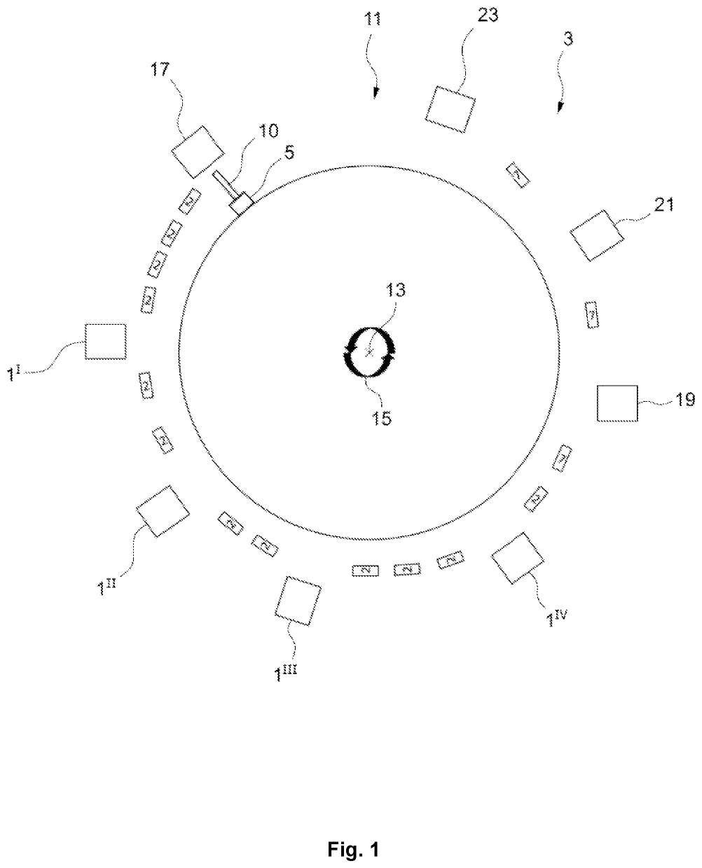

FIG. 1 a schematic illustration of a system for producing glass containers;

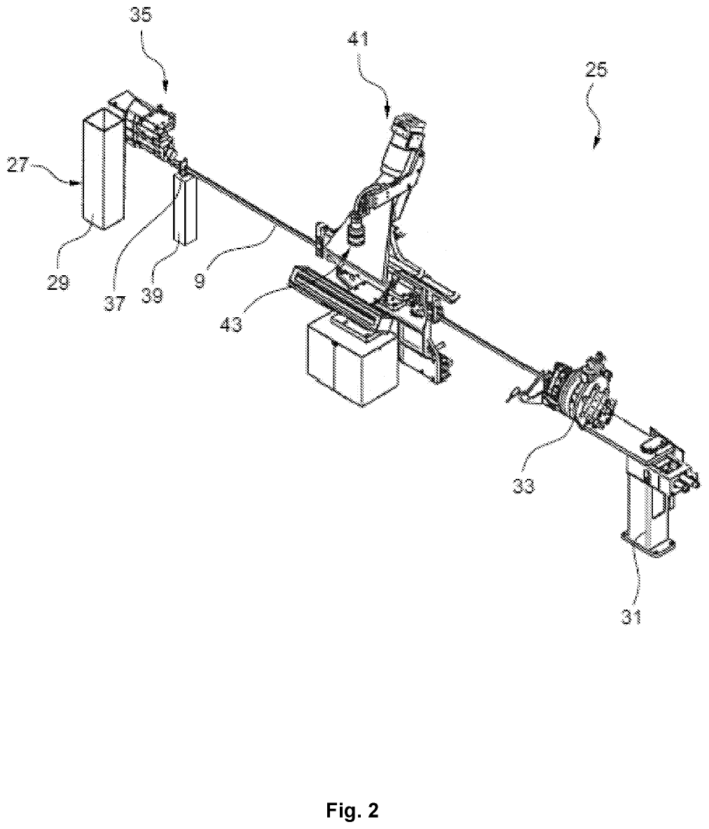

FIG. 2 a schematic perspective view of an exemplary embodiment of a cutting device of a glass container production plant according to the invention;

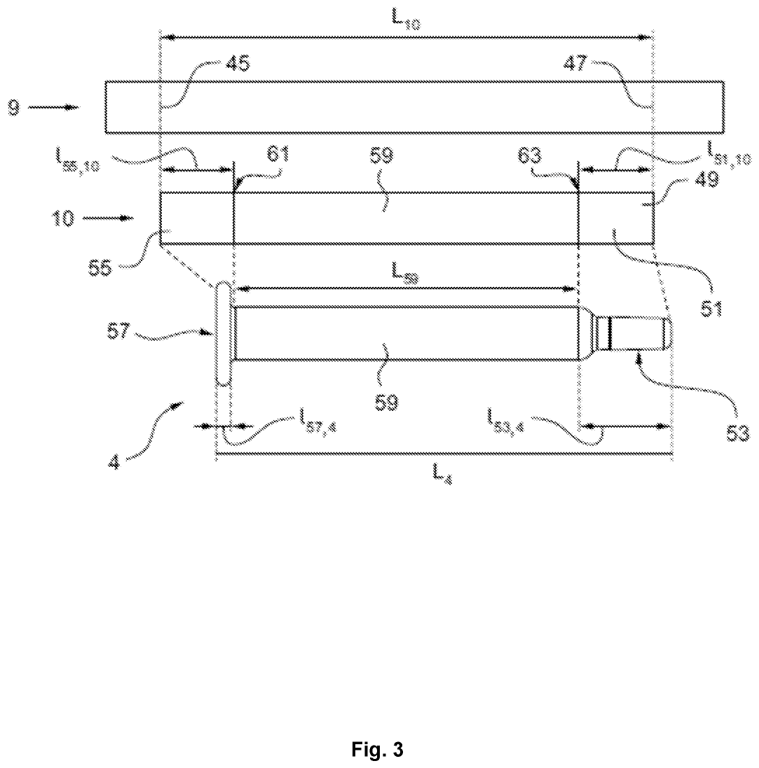

FIG. 3 a schematic representation of the manufacturing stages of a glass container according to the invention; and

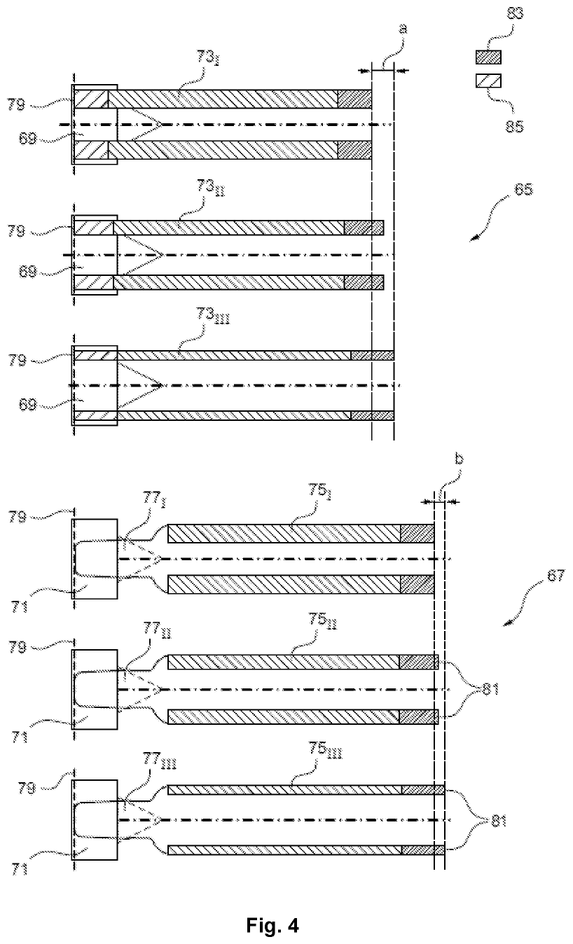

FIG. 4 a schematic representation relating to the development of excess masses or lengths of glass containers according to the prior art.

In the following description of exemplary embodiments of the invention, a glass container according to the invention is typically designated by reference sign 4. For the description of the exemplary embodiments, it can be assumed, for example, that the glass container 4 is produced from borosilicate glass. Generic glass containers 4 are used predominantly in medical or pharmaceutical use.

FIG. 1 shows a schematic illustration of an installation 3 for producing a glass container 4 in which four forming devices 1^{I}, 1^{II}, 1^{III}, 1^{IV} are depicted schematically. FIG. 1 schematically shows a receptacle 5 for rotatably holding a glass container blank 9 or a semi-finished glass container 10. The glass container blank 9 can be present, for example, as an endless blank, in particular as an endless glass tube, or prefabricated in a certain way to a predetermined axial length. In the context of the present invention, a semi-finished glass container 10 is to be understood to mean a portion separated or cut from a glass container blank 9, which portion is characterized in that it is to be further processed substantially exclusively by forming, in particular thermoforming, in order to produce the glass container 4. In the event that a semi-finished glass container 10 is inserted into the system 3, a cutting device 25 (FIG. 2) not shown in FIG. 1, such as a so-called tube cutter, can be arranged upstream of the system 3, which cutting device produces an individual semi-finished glass container 10 of an individual overall longitudinal extent, in particular axial length, from a glass container blank 9 in accordance with one of the aspects of the invention.

The system 3 comprises a carousel 11 to which the receptacle 5 is attached. The carousel 11 can be rotated about a carousel shaft 13, whereby the receptacle 10 together with the semi-finished glass container 10 can be fed to the four forming devices illustrated 1^{I}, 1^{II}, 1^{III}, 1^{IV}. The semi-finished glass container is fed successively in the circumferential direction of production 15 to the individual forming devices 1^{I}, 1^{II}, 1^{III}, 1^{IV}. Burners 2 for heating the glass intermediate 10 are arranged in each case upstream of the first forming device 1^{I} and between the subsequent forming devices 1^{II}, 1^{III} and downstream of the last forming device 1^{IV}.

A first test station 17 is provided in the circumferential direction of production 15 upstream in the direction of production of the first forming device 1^{I} in order to be able to measure and control the position and the axial run-out of the semi-finished glass container 10 in the receptacle 5.

In the circumferential direction of production 15 downstream in the direction of production of the last forming device 1^{IV} and of the last burner 2, a first cooling device 7 is provided for cooling the glass body after forming has taken place.

A second testing station 110 for checking the geometry of the glass container 4 is provided in the circumferential direction of production 15 downstream in the direction of production of the last forming device 1^{IV} and of the first cooling device 7. A second cooling device 7 and subsequently a third testing station 41 for detecting scratches and/or cracks in the glass container 4 are provided in the circumferential direction of production 15 downstream in the direction of production of the second testing station 110. A third cooling device 7 is provided downstream in the direction of production of the third testing station 41 in the circumferential direction of production 15. A transfer device 43 for transferring the glass container 4 for further processing is provided in the circumferential direction of production 15 downstream in the direction of production of the third cooling device 7. The transfer device may have means for collecting glass containers 4 ejected from the receptacle 5 and/or for transporting the glass containers 4 to a further processing station (not shown), such as, for example, a flangeforming station.

FIG. 2 shows an exemplary embodiment of a cutting device 25 for cutting semi-finished glass containers 10 of a predetermined axial length from a glass container blank 9 in abstract form and perspective view. The cutting device 25 is designed in such a way that the glass container blank 9 is substantially horizontal, which means that its axis of rotation is oriented substantially in the horizontal direction. In principle, the cutting device 25 comprises a frame 27 which has two support columns 29, 31 in the exemplary embodiment in FIG. 2. The frame 27 carries the further components of the cutting device 25. This includes, inter alia, a chuck 33 for rotatably supporting the glass tube blank 9. The chuck 33 can be, for example, a three-jaw chuck. For example, the chuck 33 has a clamping device, such as clamping jaws, for at least partially circumferentially gripping the glass container blank 9 and for fixing the glass container blank 9 inside the chuck 33. The chuck can have a drive device, not shown, by means of which the glass container blank 9 can be rotated in particular continuously about its axis of rotation, which can correspond to a central axis.

For further bearing of the elongated glass container blank, at least one bearing 37, such as, for example, an air bearing, which is arranged, for example, on a support 39, is provided between the chuck 33 and a cutting tool 35 opposite the chuck 33. By means of the air bearing, it is possible to support the glass container blank in a contactless manner and to hold it in position with respect to its direction of rotation, so that the cutting process can be performed reliably by means of the cutting tool 35. The cutting tool can be, for example, a CO₂ laser.

Furthermore, the cutting device 25 comprises a sensor system 41 for indirectly or directly detecting the basis weight of the glass container blank 9. For example, the sensor system 41 can have an optical wall thickness sensor 43 as well as a flatness sensor for measuring the flatness of an axial end face of the glass container blank or of the cut semi-finished glass container 10. The wall thickness sensor 43 is designed, for example, to detect an internal diameter, an external diameter and/or a wall thickness of the glass container blank 9 at various positions, in particular axial points, along the glass container blank, in particular while this is continuously rotated and optionally conveyed, in particular moved, with an axially translational movement.

With respect to the system 3 in FIG. 1, the cutting device 25 can be connected upstream of the system 3 in terms of production. For example, the glass container blanks 9 are cut in the cutting device 25 according to the overall longitudinal extent, detected by means of a method according to the invention, of the semi-finished glass container 10 to be formed to create the glass container 4. Subsequently, the semi-finished containers 10 are fed to the system 3. The advantages according to the invention of high product quality, low manufacturing inaccuracies or tolerances and more cost-effective production can thus be established.

FIG. 3 schematically shows the individual production stages in the production of glass containers 4 according to the invention: Starting from a glass container blank 9, a semi-finished glass container 10 corresponding to an individual, determined overall longitudinal extent L₁₀ is cut from the glass container blank 9. In FIG. 3, two axial interfaces 45, 47 are depicted by a dashed line, according to which the glass container blank 9 is cut to produce the semi-finished glass container 10. It is also possible that only one separating line 45, 47 or one cutting operation is necessary in order to produce the semi-finished glass container 10. This can be achieved by positioning the glass container blank 9 prior to cutting in such a way that a front end 49 of the glass container blank creates the front end 49 of the semi-finished glass container.

The object of the present invention is to generate the semi-finished glass container 10 for creating the glass container 4 substantially exclusively by means of forming, in particular thermoforming. To produce the glass container 4 from the semi-finished glass container 10, the individual of a leading end portion 51, from which the dispensing portion 53 is to be produced by forming, and a trailing end portion 55, from which the counter support 57 is created by forming, are formed. The dashed connecting lines between the semi-finished glass container 10 and the glass container 4 indicate which axial portion of the semi-finished glass container results in which axial portion of the glass container 4. It can be seen that a substantially cylindrical base body 59 remains substantially unchanged between the semi-finished glass container and the glass container, that is to say, has the same axial length L₅₉. In a further aspect of the present invention, an individual longitudinal extent of the leading and the trailing end portions 51, 55 is determined on the basis of the detected basis weight, from which the dispensing portion 53 or the counter support 57 are then to be formed, as indicated schematically in FIG. 3. The individual longitudinal extents of the leading end portion 51, the trailing end portion 55, or the dispensing portion 53 and the counter support 57 are indicated by the reference signs l_{55,10}, l_{51,10}, l_{57,4} and l_{53,4}.

On the basis of the longitudinal extents determined l_{55,10} and l_{51,10,} an axial deformation point on the glass container blank 9 or, as shown schematically in FIG. 3, on the semi-finished glass container 10 can be determined in order to form the dispensing portion 53 and the counter support 57. The axial deformation points 61, 63 are those axial points on the semi-finished glass container at which the forming tools for forming the semi-finished glass container for creating the finished glass container 4 with the dispensing portion 53 and the counter support 57 are to be placed. By means of the individually defined axial deformation points 61, 63 for the dispensing portion 53 and the counter support 57 as well as their axial length l_{55,10} and l_{51,1o}, it can be ensured that the in particular precisely required forming mass or melting mass is present for forming the form-specific dispensing portion 53 and the form-specific counter support 57. Excesses can thereby be avoided. The production tolerances with respect to the glass container 4 according to the invention are significantly reduced in comparison with the prior art and are approximately ±0.4 mm, or in particular ±3 mm, ±0.2 mm or ±0.1 mm.

FIG. 4 shows a schematic representation of a production process of the prior art for producing glass containers, wherein the representation focuses on the production tolerances and manufacturing inaccuracy arise. The top half of FIG. 4 indicates the forming 65 of the conical dispensing portion and the bottom half of FIG. 4 indicates the forming of the rear counter support. For each forming station 65, 67 it can be seen that three partial images are to be seen, each of which a semi-finished glass container or glass container blank 73 resp. 75 clamped in a chuck 69 or 71 are clamped. The three individual partial images are each referred to by a subscript numeral, wherein I in each case denotes the top variant in which the glass container blank 73_{I} is delivered with a wall thickness considerably greater than standard, the middle variant II represents a glass container blank 73_{II}provided according to a standard, that is, with no and/or substantially negligible production tolerance, and the bottom variant III in each case represents a glass container blank 73_{III} delivered with a considerably reduced wall thickness compared to the standard. Reference sign 75 denotes the glass container blank in each case, which already has a formed dispensing portion 77_{I,II,III}. The respective reference for determining the length tolerances or length inaccuracies on the glass container blanks 73, 75 is indicated in each case by an axial stop of the glass container blank 73, 75 in the chuck 69 which is indicated by the reference sign 79. As can be seen in FIG. 4, the glass container blanks 73 provided have a length tolerance a, in particular an overall length tolerance. In the production process, the dispensing portion 77 is usually formed first and then the counter support. In FIG. 4, above, it is schematically indicated which volumes, in particular masses, have to be provided on the glass container blanks 73_{I-III} in each case in order to subsequently form the dispensing portion 77_{I-III} and the counter support. Reference sign 83 denotes the counter support volume and reference sign 85 denotes dispensing portion volume. It can be seen that the necessary axial length varies as a function of the wall thickness of the glass container blanks 73_{I-III}. In order to offset the overall length tolerance a and to prevent glass containers 4 from being produced outside the permissible tolerance, a permissible tolerance b is estimated as to how the glass container blanks 73_{I-III} are permitted to deviate from one another so that glass containers 4 can still be produced within the production tolerance. It can be seen that, in the production of a glass container 4 according to standard, bottom of FIG. 4, variant II, an excess length 81 is provided, which subsequently has to be separated in an additional work step. It is clear that the excess length 81 is also present in the minimum wall thickness, FIG. 4, bottom, variant III. This additional work step impairs the quality of the glass container 4 and requires an additional step and thus costs.

The features disclosed in the above description, the figures, and the claims may be important both individually and in any combination for realizing the invention in the various embodiments.

### LIST OF REFERENCE SIGNS

1 Forming device (1^{I}, 1^{II}, 1^{III}, 1^{IV}, 1^{V})
2 Burner
3 System
4 Glass container
5 Receptacle
7 Cooling device
9 Glass container blank
10 Semi-finished glass container
11 Carousel
13 Carousel axis
15 Circumferential direction of production
17 First test station
19 Second test station
21 Third test station
23 Transfer device
25 Cutting device
27 Frame
29, 31 Column
33 Chuck
35 Cutting tool
37 Bearing
39 Bearing column
41 Sensor system
43 Wall thickness sensor
45, 47 Cut line
49 End
51, 55 End portion
53 Dispensing portion
57 Counter support
59 Base body
61, 63 Axial deformation point
65, 67 Forming
69, 71 Chuck
73 Glass container blank variant I, II, III
75 Glass container blank with formed dispensing portion variant I, II, III
77 Dispensing portion variant I, II, III
79 Chuck stop
81 Excess length
83 Counter support volume
85 Dispensing portion volume
Lᵢ Length of the respective component i (glass container, base body, semi-finished glass container or glass container blank)
L_{x,i} Length of the respective portion x of component i (glass container, semi-finished glass container or glass container blank)
a Overall length tolerance
b Tolerance

1.-20. (canceled)

21. A method for producing a glass container having a form-specific dispensing portion and optionally a form-specific counter support, from a glass container blank, comprising the steps of:
indirectly or directly detecting the basis weight of the glass container blank; and
determining, on the basis of the detected basis weight, an individual overall longitudinal extent of a semi-finished glass container to be formed to create the glass container.

22. The method according to claim 21, wherein the semi-finished glass container is cut from the glass container blank according to the overall longitudinal extent determined.

23. The method according to claim 21, wherein an individual longitudinal extent of a leading end portion, from which the dispensing portion is to be formed, and optionally of a trailing end portion, from which the counter support is to be formed, is/are determined on the basis of the detected basis weight of the glass container blank, and wherein the overall longitudinal extent of the semi-finished glass container is determined on the basis of the determined longitudinal extent.

24. The method according to claim 23, wherein the separated semi-finished glass container is heated at least in portions in order to form the dispensing portion and optionally the counter support.

25. The method according to claim 21, wherein a deformation behavior of the semi-finished glass container during heating and/or forming of the dispensing portion and optionally of the counter support is anticipated on the basis of a glass-specific material constant, and wherein the overall longitudinal extent is determined taking into account the anticipated deformation behavior.

26. A method for producing a glass container having a form-specific dispensing portion and optionally a form-specific counter support, from a glass container blank, comprising the steps of:
heating the glass container blank at least in portions in order to form the dispensing portion and optionally the counter support; and
indirectly or directly detecting the basis weight of the glass container blank before forming the dispensing portion and optionally the counter support;
determining, on the basis of the detected basis weight of the glass container blank, an individual longitudinal extent of a leading end portion, from which the dispensing portion is to be formed, and optionally of a trailing end portion, from which the counter support is to be formed, is/are on the basis of the detected basis weight of the glass container blank; and
determining an axial deformation point on the glass container blank on the basis of the determined longitudinal extent(s) to create the dispensing portion and optionally the counter support.

27. The method according to claim 26, wherein the axial deformation point is defined such that an axial end portion of the glass container blank delimited by the axial deformation point has a predetermined mass for creating the dispensing portion and optionally the counter support.

28. The method according to claim 26, wherein a semi-finished glass container to be formed to create the glass container is cut from the glass container blank according to a predefined or predetermined overall longitudinal extent.

29. The method according to claim 26, comprising determining or measuring a flatness of an axial end face of the glass container blank or of the cut semi-finished glass container.

30. The method according to claim 26, wherein the glass container blank or the cut semi-finished glass container is positioned on the basis of the axial deformation point and optionally of the flatness of the axial end face with respect to a forming tool for creating the dispensing portion and optionally the counter support.

31. The method according to claim 26, wherein a deformation behavior of the glass container blank or semi-finished glass container during heating and/or forming of the dispensing portion and optionally of the counter support is anticipated on the basis of a glass-specific material constant, and the longitudinal extent of the dispensing portion to be formed and optionally of the counter support to be formed is determined on the basis of the anticipated deformation behavior.

32. The method according to claim 26, comprising detecting an external diameter, an internal diameter and/or a wall thickness of the glass container blank, and determining the basis weight of the glass container blank, on the basis of the measured external diameter, the internal diameter and/or the wall thickness.

33. A glass container comprising a cylindrical base body, a tapering dispensing portion connecting to the base body, wherein the dispensing portion creates a front open end of the glass container and a rear end, optionally formed as counter support, which is in contact with the base body, wherein the front and the rear open ends are thermally cut.

34. The glass container according to claim 33, wherein the overall longitudinal extent is subject to a tolerance of +/−0.4 mm.

35. A glass container produced by the method according to claim 21.

36. A system for producing a glass container having a form-specific dispensing portion and optionally a form-specific counter support, from a glass container blank, said system comprising:
sensor system for indirectly or directly detecting the basis weight of the glass container blank; and
a processor unit designed to determine an individual overall longitudinal extent of a glass container to be formed to create the glass container on the basis of the detected basis weight.

37. The system according to claim 36, further comprising a cutting tool for cutting the semi-finished glass container according to the determined overall longitudinal extent of the glass container blank, wherein the sensor system is upstream of the cutting tool.

38. The system according to claim 36 comprising:
a heat source, such as a burner, for at least partially heating the glass container blank;
a forming tool designed to deform the heated glass container blank in order to create the dispensing portion and optionally the counter support;
a sensor system for indirectly or directly detecting the basis weight of the glass container blank, wherein the sensor system is upstream of the forming tool; and
a processor unit designed to determine an individual longitudinal extent of a leading end portion, from which the dispensing portion is to be formed, and optionally of a trailing end portion, from which the counter support is to be formed; and to determine an axial deformation point on the glass container blank for the forming tool on the basis of the determined longitudinal extent(s) in order to form the dispensing portion and optionally the counter support.

39. The system according to claim 36, wherein the sensor system for detecting the basis weight comprises an optical sensor device for measuring an external diameter, an internal diameter and/or a wall thickness of the glass container blank, and/or for measuring the flatness of an axial end face of the glass container blank or of the cut semi-finished glass container product.

40. A system for producing a glass container having a form-specific dispensing portion and optionally a form-specific counter support, from a glass container blank, said system configured to carry out the method according to claim 21.
